(19) United States
(12) Patent Application Publication
(10) Pub. No.: US 2003/0035871 A1
(43) Pub. Date: Feb. 20, 2003

(54) Additive delivery system for rollstock machines

(76) Inventors: Chris Topps, San Juan Capistrano, CA (US); Marc Rinehart, Redlands, CA (US)

Correspondence Address: Emery L. Tracy, P.O. Box 1518, Boulder, CO, 80306-1518, US

(21) Appl. No.: 09/930,893

(22) Filed: Aug. 16, 2001

(51) Int. Cl. A23B 4/00

(52) U.S. Cl. 426/410

(57) ABSTRACT

An additive delivery system for applying additives to a food product on a rollstock machine is provided. The rollstock machine has a forming film formed into at least one cavity with each cavity receiving a food product. The additive delivery system comprises a first additive delivery device secured to the rollstock machine and a second additive delivery device secured to the rollstock machine with the second additive delivery device being spaced from the first additive delivery device. At least one first nozzle is formed in the first additive delivery device for delivering at least one additive into at least one of the cavities prior to each cavity receiving a food product and at least one second nozzle is formed in the second additive delivery device for delivering at least one additive onto the food product within the cavity.

### BACKGROUND OF THE INVENTION

1. Field of the Invention

This invention relates generally to an additive delivery system for rollstock machines and, more particularly, it relates to an additive delivery system for a rollstock machine which applies an additive about and to a food product during packaging of the food product on the rollstock machine.

2. Description of the Prior Art

The use of rollstock machines by food processors to prepare and package food products for sale to the consumer are known in the art. Rollstock machines typically include a forming film applied to a conveyor system prior to loading of the food products with the forming film creating a plurality of cavities for receiving the food product. Once the food product is loaded into the cavity, a covering film is placed over the loaded food products. The covering film is then sealed to the forming film to create distinct, separable food packages. The packages of food product are then separated from each adjacent food product package.

In many instances, the food products must be cooked prior to being sold to the consumer. Therefore, after the food product has been packaged on the rollstock machine, the packaged food product can be transported to an oven or the like for cooking. After the food product has been cooked and since many cooked products, especially processed meat products, do not have the desired flavor or color, the food processor or operator then must remove the food product from the film packaging and introduce liquid smoke, colorant, or other similar additives to the food product. The treated food products are then transported back to the rollstock machine and repackaged for shipping to the ultimate consumer.

Unfortunately, requiring the operator to package, cook, unpackage, introduce additive, and repackage is quite time consuming and expensive for the food processor and the rollstock machine operator. Accordingly, there exists a need for an additive delivery system for rollstock machines which allows an additive to be applied to one or both sides of the food product during packaging of the food product. Additionally, a need exists for an additive delivery system for rollstock machines which is securable directly to the rollstock machine to introduce the desired additive to the food product. Furthermore, there exists a need for an additive delivery system which is controllable and adjustable through operation of the rollstock machine thereby allowing a food processor to vary the amount and type of additive introduced to each food product.

### SUMMARY

The present invention is an additive delivery system for applying additives to a food product on a rollstock machine. The rollstock machine has a forming film formed into at least one cavity with each cavity receiving a food product. The additive delivery system comprises a first additive delivery device secured to the rollstock machine and a second additive delivery device secured to the rollstock machine with the second additive delivery device being spaced from the first additive delivery device. At least one first nozzle is formed in the first additive delivery device for delivering at least one additive into at least one of the cavities prior to each cavity receiving a food product and at least one second nozzle is formed in the second additive delivery device for delivering at least one additive onto the food product within the cavity.

The present invention additionally includes a method for applying additive to a food product on a rollstock machine. The method comprises forming at least one cavity from a forming film, applying a first additive to each cavity, loading a food product into each cavity, applying a second additive to each food product, and sealing a non-forming film to the forming film over the food product.

The present invention additionally includes an apparatus for treating food products with an additive. The apparatus comprises at least one cavity for receiving a food product and a first additive delivery device positioned above each cavity. First nozzle means are mounted to the first additive delivery device for applying a first additive to each cavity prior to receiving the food product. Preferably, a second additive delivery device is positioned above each cavity with second nozzle means mounted to the second additive delivery device for applying a second additive to the food product within each cavity.

### BRIEF DESCRIPTION OF THE DRAWINGS

FIG. 1 is a perspective view illustrating an additive delivery system, constructed in accordance with the present invention, mounted on a rollstock machine for applying an additive to a food product;

FIG. 2. is an elevational side view illustrating the additive delivery system of FIG. 1, constructed in accordance with the present invention, mounted on another type of rollstock machine;

FIG. 3 is a top schematic view illustrating the additive delivery system of FIG. 1, constructed in accordance with the present invention;

FIG. 4 is a side schematic view illustrating the additive delivery system of FIG. 1, constructed in accordance with the present invention, with additive being applied through spray nozzles prior to loading of the food product;

FIG. 5 is another side schematic view illustrating the additive delivery system of FIG. 1, constructed in accordance with the present invention, with additive being applied only through certain predetermined spray nozzles; and

FIG. 6 is another top schematic view illustrating the additive delivery system of FIG. 1, constructed in accordance with the present invention.

### DETAILED DESCRIPTION OF THE PREFERRED EMBODIMENTS

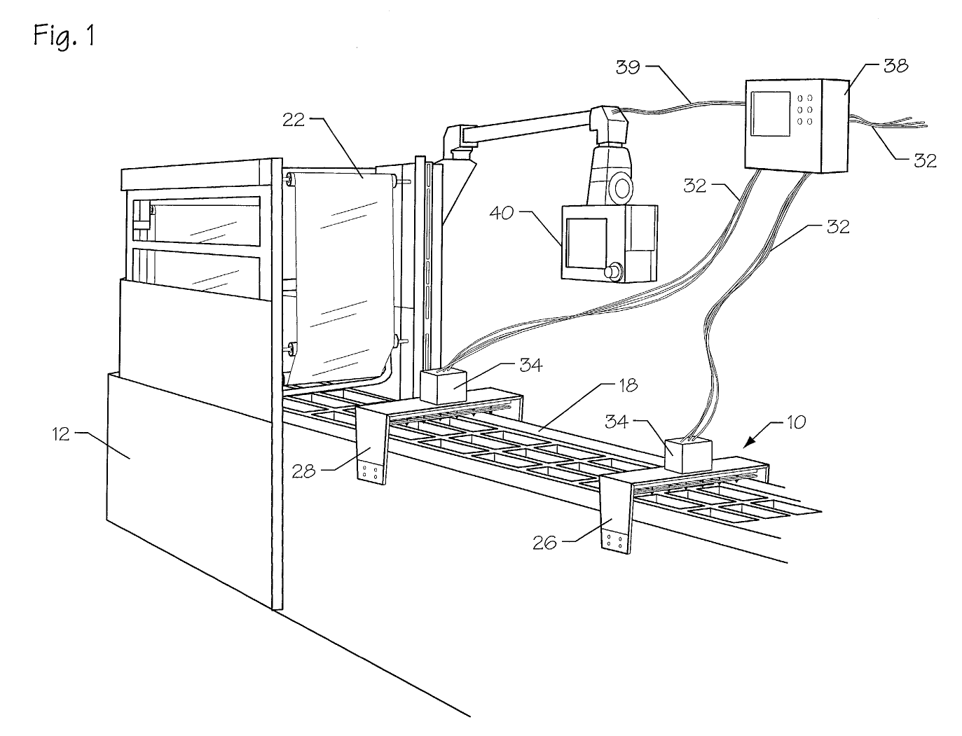

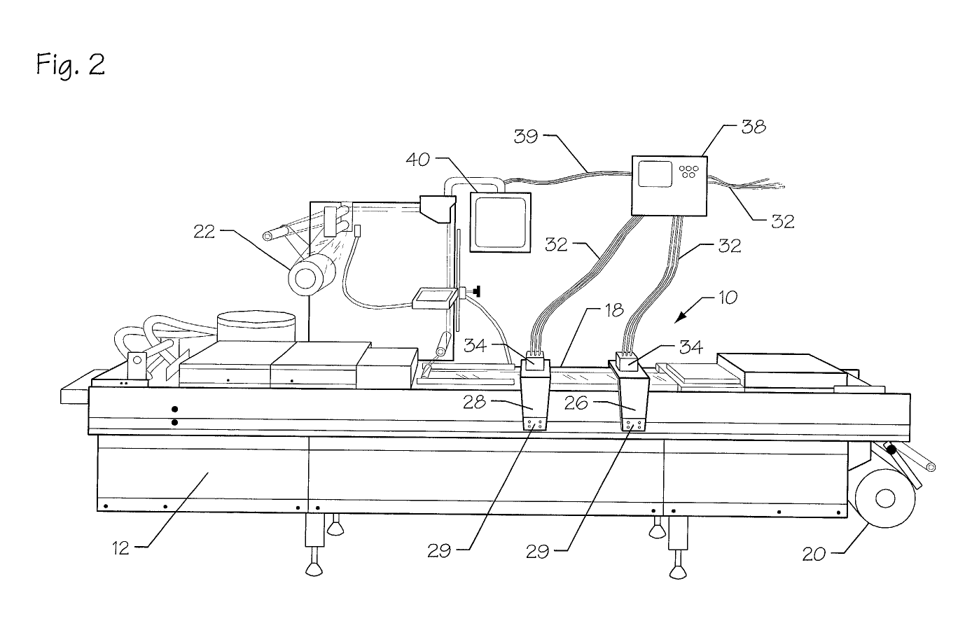

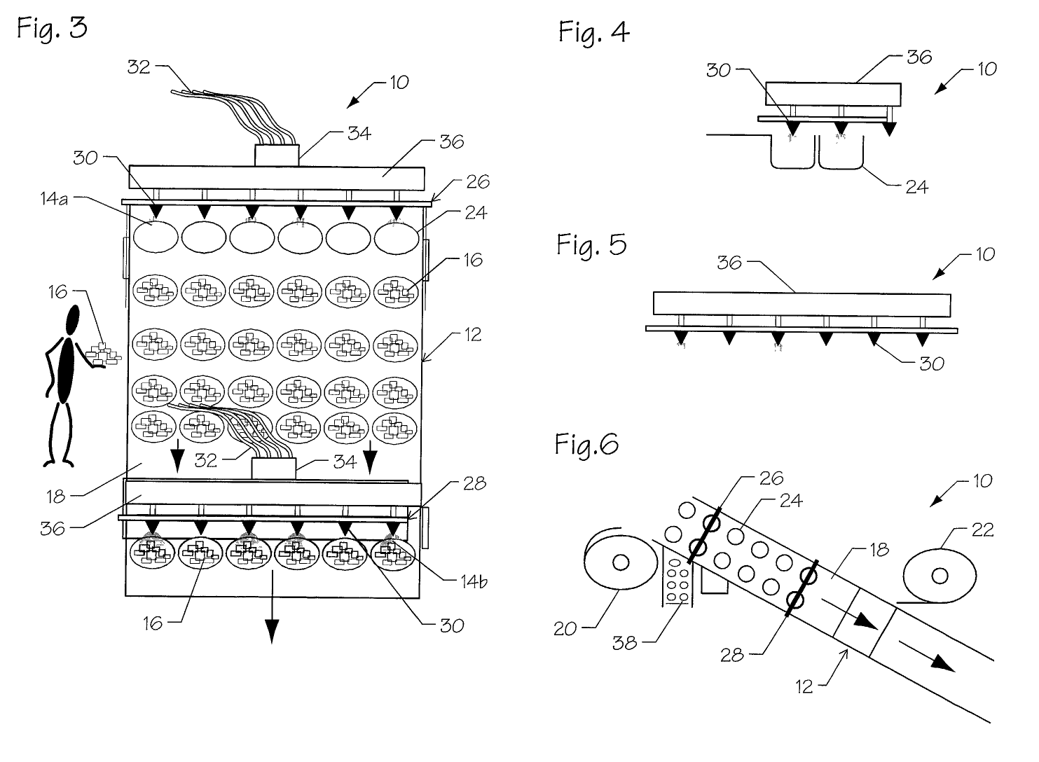

As illustrated in FIGS. 1 and 2, the present invention is an additive delivery system, indicated generally at 10, for rollstock machines 12. The additive delivery system 10 of the present invention allows a food processor or other food packager to introduce an additive 14 (as illustrated in FIG. 3) to a food product 16 (as illustrated in FIG. 3) prior to packaging and cooking of the food product 16 without having to unpackage and repackage the food product 16 prior to shipping of the food product to the wholesaler, retailer, or consumer.

In brief, the rollstock machine 12 includes a conveyor system 18 between a forming film supply 20 and a covering film supply 22. As the conveyor system 18 moves in a predetermined direction, as indicated by the arrows in FIGS. 3 and 6, the forming film 20 is applied on top of the conveyor system 18 to form a plurality of cavities 24, as illustrated in FIG. 4. The cavities 24 are formed in rows along the conveyor system 18 to receive the food products 16, as illustrated in FIG. 3. First additives 14a are added to each cavity 24 from the additive delivery system 10 with the food processor then loading the desired food product 16 into each cavity 24 as the food product moves along the conveyor system 18. Second additives 14b are then added directly to the food product 16 from the additive delivery system 10. It should be noted, as will be described in further detail below, the first additive 14a and the second additive 14b can be the same additive 14 or different additives 14 depending on the desires of the food processor. The covering film 22 is then applied over the treated food product 16 with the covering film 22 being sealed to the forming film 20 thereby packaging the food product 16 between the forming film 20 and the covering film 22.

The additive delivery system 10 of the present invention will now be described in detail. As mentioned above, the additive delivery system 10 allows the food processor to apply an additive 14, e.g., liquid smoke, other flavors, or coloring agents to the cavities 24 created by the forming film 20 and/or the food product 16 prior to cooking and/or shipping the food product 16. In a preferred embodiment, as illustrated in FIG. 4, the additive delivery system 10 includes a first additive delivery device 26 and a second additive delivery device 28. The first additive delivery device 26 is preferably mounted to the rollstock machine 12 in a position prior to a food loading area for introducing the first additive 14a directly to each cavity 24. The second additive delivery device 28 is preferably mounted to the rollstock machine 12 subsequent to the food loading area for introducing the second additive 14b directly to the food product 16. The first additive delivery device 26 and the second additive delivery device 28 device are preferably mounted directly to the rollstock machine 12 by a plurality of bolts 29 or the like although any type mounting means for mounting the first additive delivery device 26 and the second additive delivery device 28 to the rollstock machine 12 are within the scope of the present invention.

It should be noted that the additive delivery system 10, including the first additive delivery device 26 and second additive delivery device 28, can be affixed to any type of rollstock machine 12 for introducing the additives 14 such as flavorings and seasoning in powder and/or liquid forms which are dispensed by air and/or water pressure, light impulse or electrostatic charge, etc. The additive delivery system 10 is adjustable for all sizes of rollstock machines 12 and can include adapters for accommodating any particular rollstock machine 12. The means for delivery of the additives through the additive delivery system 10, i.e., the first additive delivery device 26 and the second additive delivery device 28 will be described in further detail immediately below.

The first additive delivery device 26 and the second additive delivery device 28 each include at least one spray nozzle 30 with each spray nozzle 30 connected to an additive supply (not shown) by a flexible pipe or hose 32. As illustrated in FIG. 4, the flexible pipe or hose 32 delivers the first additives 14a to the first additive delivery device 26 and the second additives 14b to the second delivery device 28 from the additive supply to a product collection area 34 mounted to both the first additive delivery device 26 and the second delivery device 28 for mixing the additives 14a, 14b in a desired manner prior to application to the cavities 24 and the food product 16. From the product collection area 34, the additives 14a, 14b are delivered to a high-pressure delivery canal 36 on both the first additive delivery device 26 and the second additive delivery device 28 for dispensing the additives 14a, 14b through the spray nozzles 30. As mentioned above, each high pressure delivery canal 36 is pressurized by any method including, but not limited to, water pressure, air pressure, light impulse, electrostatic charge, etc., for dispensing the additives 14a, 14b through the spray nozzles 30 into each cavity 24 and/or onto the food product 16.

It should be noted that, preferably, both the first additive delivery device 26 and the second additive delivery device 28 have a plurality of spray nozzles 30 to introduce the first additive 14a and the second additive 14b, respectively, to each cavity 24 and each food product 16, respectively, on the rollstock machine 12. Furthermore, all spray nozzles 30 can introduce the same additive 14, some of the spray nozzles 30 can be closed in order to run multiple different food products 16 simultaneously with and without additives 14 added, or different additives 14 can be applied to different food products 16 through different spray nozzles 30 to allow multiple different food products 16 in any given cavity 24 to have different tastes and/or colors.

As illustrated in FIG. 6, the additive delivery system 10 of the present invention further includes a meter control panel 38 to control operation of the first additive delivery device 26 and the second additive delivery device 28. The meter control panel 38 will interconnect with the computer control panel 40 of the rollstock machine 12 via wires 39 or the like for dispensing the additives 14 in accordance with the cycling of the rollstock machine. The meter control panel 38 will measure and dispense the appropriate predetermined amount of additive 14 and maintain records of all additives 14 passing through the additive delivery system 10.

The operation of the additive delivery system 10, including the first additive delivery device 26 and the second additive delivery device 28, will now be described in detail. A person skilled in the art will understand that the description of the operation of the additive delivery system 10 described below is only one manner of operation and that other manners of operation are within the scope of the present invention.

As the forming film 20 is applied to the conveyor system 18 of the rollstock machine 12, the cavities 24 are formed for receiving the food product 16. Prior to receiving the food product 16, the first additives 14a are applied from the first additive delivery device 26 into the cavities 24 within a predetermined number or all of the cavities 24. Once the desired first additives 14a are applied into the cavities 24, the food processor loads the food product 16 directly into the cavities 24. Then, the second additive 14b is applied directly to the food product 16 directly from the second additive delivery device 28. The covering film 22 is then applied over the food product 16 and sealed to the forming film 20. The packaged, seasoned food product 16 can then be sent to the ovens for cooking or shipped directly to the consumer. There is no need to unpackage and repackage the food products 16 after cooking in order to cold smoke, and/or add the appropriate colorings, seasonings, and/or flavorings.

The additive 14 of the additive delivery system 10 of the present invention can be applied by a food adhesive or some other contact agent to allow the additive 14 to adhere to the inside of the forming film 20 and the covering film 22, when desired.

The additive delivery system 10 of the present invention allows a food processor to package and cook food products 16 with a desired flavor and/or coloring without having to unpackage the packaged food product 16 and handle the food product 16 after cooking. This allows substantially reduced processing times thereby reducing costs to the food processor and the consumer. Furthermore, the additive delivery system 10 can be attached to any type of rollstock machine 12 without affecting the normal and customary operation of the rollstock machine 12.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. An additive delivery system for applying additives to a food product on a rollstock machine, the rollstock machine having a forming film formed into at least one cavity, each cavity receiving a food product, the additive delivery system comprising:
a first additive delivery device secured to the rollstock machine;
a second additive delivery device secured to the rollstock machine, the second additive delivery device being spaced from the first additive delivery device;
at least one first nozzle formed in the first additive delivery device for delivering at least one additive into at least one of the cavities prior to each cavity receiving a food product; and
at least one second nozzle formed in the second additive delivery device for delivering at least one additive onto the food product within the cavity.

2. The additive delivery system of claim 1 and further comprising:
a plurality of first nozzles positioned in a spaced relation along the first additive delivery device; and
a plurality of second nozzles positioned in a spaced relation along the second additive delivery device.

3. The additive delivery system of claim 2 wherein each first nozzle is closable independently of the remaining first nozzles and wherein each second nozzle is closable independently of the remaining second nozzles.

4. The additive delivery system of claim 2 wherein each first nozzle can dispense additives different than the additives dispensed from the remaining first nozzles and wherein each second nozzle can dispense additives different than the additives dispensed from the remaining second nozzles.

5. The additive delivery system of claim 1 and further comprising:
a plurality of hoses for delivering additives to the first nozzles and the second nozzles.

6. The additive delivery system of claim 5 and further comprising:
a first product collection area associated with the first additive delivery device; and
a second product collection area associated with the second additive delivery device;
wherein the first product collection area and the second product collection area collects additives from the hoses and mixes the additives prior to delivery to the first nozzles and the second nozzles, respectively.

7. The additive delivery system of claim 6 and further comprising:
a first pressurized delivery canal for receiving the additives from the first product collection area, each first nozzle being connected to the first pressurized delivery canal; and
a second pressurized delivery canal for receiving additives from the second product collection area, each second nozzle being connected to the second pressurized delivery canal.

8. The additive delivery system of claim 1 wherein the additive is selected from the group consisting of coloring, flavoring, liquid smoke, and seasonings.

9. A method for applying additive to a food product on a rollstock machine, the method comprising:
forming at least one cavity from a forming film;
applying a first additive to each cavity;
loading a food product into each cavity;
applying a second additive to each food product; and
sealing a non-forming film to the forming film over the food product.

10. The method of claim 9 and further comprising:
forming a plurality of cavities from the forming film;
applying the first additive to only a predetermined number of cavities;
loading a food product into each of the cavities; and
applying the second additive to only a predetermined number of food products.

11. The method of claim 10 and further comprising:
maintaining at least one cavity and the food product within that cavity free from the first additive and the second additive.

12. The method of claim 9 and further comprising:
pressurizing the first additive and the second additive.

13. An apparatus for treating food products with an additive, the apparatus comprising:
at least one cavity for receiving a food product;
a first additive delivery device positioned above each cavity; and
first nozzle means mounted to the first additive delivery device for applying a first additive to each cavity prior to receiving the food product.

14. The apparatus of claim 13 and further comprising:
a second additive delivery device positioned above each cavity; and
second nozzle means mounted to the second additive delivery device for applying a second additive to the food product within each cavity.

15. The apparatus of claim 13 wherein each cavity is formed from a forming film capable of forming a cavity.

16. The apparatus of claim 14 and further comprising:
a covering film for covering the food product, the covering film sealable to the forming film.

17. The apparatus of claim 13 wherein the first additive is different from the second additive.

18. The apparatus of claim 13 and further comprising:
a plurality of cavities;
wherein the first additive is applied to only a predetermined number of cavities.

19. The apparatus of claim 18 wherein the second additive is applied to only a predetermined number of food products.

20. The apparatus of claim 19 and further comprising:
additional additives applied to a predetermined number of cavities and food products which do not include the first additive and the second additive, respectively.
